(19) United States
(12) Patent Application Publication
(10) Pub. No.: US 2023/0302354 A1
(43) Pub. Date: Sep. 28, 2023

(54) ONLINE GAME

(71) Applicants: Manuel KIERSPEL, Cologne (DE); Florian FELTER, Darmstadt (DE); Markus Rainer Dieter Winkler, Darmstadt (DE)

(72) Inventors: Manuel KIERSPEL, Cologne (DE); Florian FELTER, Darmstadt (DE); Markus Rainer Dieter Winkler, Darmstadt (DE)

(21) Appl. No.: 17/705,493

(22) Filed: Mar. 28, 2022

(51) Int. Cl. A63F 13/46; A63F 13/79; A63F 13/63; A63F 13/655; A63F 13/44; A63F 13/335; A63F 13/87

(52) U.S. Cl. CPC A63F 13/46; A63F 13/79; A63F 13/63; A63F 13/655; A63F 13/44; A63F 13/335; A63F 13/87

(57) ABSTRACT

A method in an online social platform for online game between a networking system and users' device and content to be shared in a network service. An exemplary method includes creating in a content creator a challenge to invite users in a game and sending an invitation to the users' device to accept the created challenge in a predetermined time via a network and expiring in the networking system, a predetermined time when a networking system does not receive a response from a user's device to accept the challenge in the predetermined time and sending a content from a user application to a data stores in the networking system via a network in a predetermined time after the response is received from a user's device, wherein the content is a proof video accomplishing the challenge and the content that is to be shared with a set of one or more users of the network service. The method includes deciding whether the content is uploaded on a data stores in the predetermined time and voting in the users' device, a positive or a negative point in a predetermined time when the uploaded content is shared between the users' device; and collecting a sum of the points from the voting and saving the collected points on a user's account.

### TECHNICAL FIELD

The present invention relates to a digital social platform for users to create and share video content, which is designed to enable users to participate in a digital contest that is based on the content.

### BACKGROUND

An online game is a game played over some form of a computer network, such as the Internet. The expansion of online gaming has reflected the overall expansion of computer networks from small local networks to the Internet and the growth of Internet access itself. Online games can range from simple text-based games to games incorporating complex graphics and virtual worlds populated by many players simultaneously. Many online games have associated online communities, making online games a form of social activity beyond single player games. Conventionally, a method for operating a live hosted multiplayer online game is provided. The method includes the steps of registering a plurality of online game clients to participate in the live hosted multiplayer online game; registering a live host console to provide a user interface for a live host to control and monitor the live hosted multiplayer online game; publishing a question to the plurality of online game clients; receiving a set of responses from the plurality of responses received from the plurality of online game clients; creating a summary of the set of responses received from the plurality of online game clients; sending the summary of the set of responses to the live host console; receiving an event request from the live host console; and transmitting a game content to the plurality of client online game clients in response to the event request. However, when many new Internet-based online games work, they typically offer a game challenge with traditional feedback interactions. The lack of dynamic and flexibility of games discourages users to participate a game. Moreover, all users, no matter what games they are in, receive the restricted number of challenges given by a host and thus the possibility of earning the same number of points, which are already determined. Thus, direct comparisons between users, although not encouraged, are possible. Such comparisons between players under the lack of feedback from other users and simple awards to a winner can lead to user disappointment in the game. For example, a traditional structure that streams video over the Internet is not interactive such as “making of” video, games, or director's commentary (stream the material.) This is often due to the fact that the interactive material is made based on an ineffective feedback and structures intended for audiences and participants that handle interactivity locally. Inflexible game challenges and ineffective awarding systems are problems waiting for solution. Moreover, in the digital age, there is much information that people want to share with other people, including pictures, lists, music, etc. video file sharing has typically been achieved through conventional file server. Hence, a user that wants to share a video file with other users will share it through endpoint devices for an online game. Endpoint devices such as phones, computer, television, and so forth are an important part of the fabric of everyday life, and the way people communicate, so that sharing files to and from these endpoint devices is ever more desirable.

With the increasing demands of customers for ever richer gaming experiences, advances in online games are needed.

### SUMMARY

The game named “CHLNGE” by the inventor is an online game, which can be operated by practically unlimited number of USERs (“USERS”) at the most diverse locations and at the most diverse times together and/or one after the other via the Internet. CHLNGE is a digital social platform where USERs can create and share video content. It is designed to allow USERs to participate in a digital competition based on the content giving it more flexibility. Participation is uploaded and shared through the medium of video. The entirety of the USERs is referred to as the “COMMUNITY,” and the respective competition leaders as the “HOST”. In concrete terms, it is an online game that can be accessed from a computer by logging onto a designated web page or via a mobile device with the help of an app. The purpose of the game is to accept (competition) tasks (“CHALLENGES”) defined by the operator (“ADMIN”), if applicable, also by the USERS, to solve them, to post the solution online in a suitable manner within a specified time and to have it evaluated by the other PARTICIPANTs. In this way, all USERS who have accepted the same task and solved it within the specified time (“PARTICIPANTS”) collect points (“VOTES”), which are summed up in a competition table and assign a table position to the PARTICIPANTS as effective awarding points. The ADMIN moderates and provides functions such as the verification of CHALLENGES, counting of points, updating of the table position, and transfer of points.

USERs can create “CHALLENGES” that include producing a video and requirements to complete the tasks. CHALLENGES proposed by USERs are verified by the ADMIN. USERs can invite other USERs to participate in these challenges, in which case the USERs become the “HOST”. USERs can decide for themselves whether they want to participate in these challenges; if they accept them, USERs become PARTICIPANTS. USERs can follow the video content of the PARTICIPANTS. USERs can decide whether PARTICIPANTs have completed a challenge by distributing upvotes or downvotes, which are counted by the ADMIN. By participating in a challenge, USERs also participate in a contest. USERs can not only rate videos, but also comment on them and share them with third parties who are not in a game. USERs can follow other USERs. Dynamic transitions between USERs and HOST for a game gives more dynamic environments for an online game and effective feedback or grades for each challenger can attract more users compared to conventional online games.

### BRIEF DESCRIPTION OF THE DRAWINGS

In order to clearly illustrate the technical solution of the embodiments of the present disclosure, the drawings of the embodiments will be briefly described in the following. It is apparent that the described drawings are only related to some embodiments of the present disclosure and thus are not limitative of the present disclosure.

FIG. 1 is an illustration of an example network environment of a system including a networking system of the online game that offers its users the ability to communicate and interact with other users and entities of the networking system according to an embodiment of the invention;

FIG. 2 is a diagram of a digital social platform for users to create and share Video content and is designed to enable users to participate in a digital contest that is based on the content and participation is uploaded and shared via Video as a medium; and

FIG. 3 is a diagram of a user joining challenged independently and the user will have to accomplish the challenge in a given deadline.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

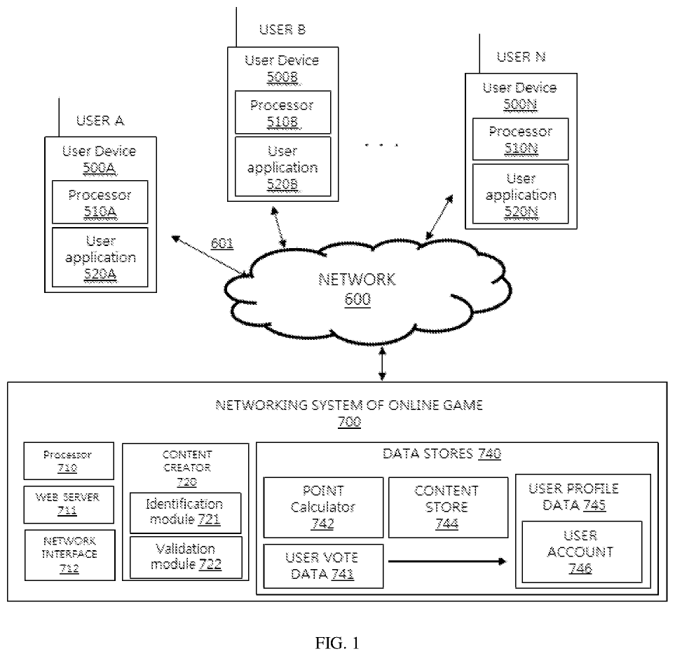

As shown in FIGS. 1-3, “CHLNGE” is a digital social platform for users to create and share Video content. It is designed to enable users to participate in a digital contest that is based on the content. Participation is uploaded and shared via Video as a medium. Users can create tasks/exercises (challenges) including a video and requirements to accomplish the challenges. Users can invite other users to participate in these challenges. Users can decide on their own to participate in these challenges. Users can consume the video content of participants. Users can decide whether participants accomplished a challenge by upvote or downvote. By participating in a challenge, users also participate in a contest. Users can comment on a Video. Users can share a Video. Users can follow other users. Users can search for challenges, users.

The game concept and the competition pursued are based on the decisions of the community. The performance of each PARTICIPANT in a challenge can be evaluated by each member of the community with an upvote or downvote. Each PARTICIPANT in the contest is represented in a table (“LEADERSHIP BOARDS”) maintained by the respective HOST. The spreadsheet contains information about the PARTICIPANT's name, nationality, total score, and placement. To win the competition, PARTICIPANTS can earn points in term of VOTES by taking part in challenges. The sum of the collected points in relation to the other PARTICIPANTs determines the ranking of the PARTICIPANTS in the table.

USERs can participate in a challenge independently and must complete it within a time limit set by the HOST or other PARTICIPANTS. USERs can also create and send invitations to other USERs to challenge them; in these cases, the inviting PARTICIPANTS themselves become the HOST. To incentivize interactions with these invitations, a limited validity period is set. Once a HOST sends the invitations, the invited USERS have a limited window of time to respond and decline or accept the invitation. If a USER accepts the invitation, he/she has the same time window as any other PARTICIPANT in the same challenge. If a USER, who has confirmed his/her participation, cannot solve the challenge within the given time or cannot put the proof online, he/she will not receive any points; instead, the number of points specified for this challenge will be credited to the respective HOST. No points are taken from the USER failing to solve or upload his/her video. The number of points credited to the HOST is determined and transferred by the ADMIN.

The following is an example of a challenge based on the present embodiment. The host invites participants to take part in a push-up competition. Each invited competitor must confirm their participation within a defined period of time and then has another defined period of time to prove the number of push-ups they have managed per unit of time by uploading a video. The other competitors then evaluate the performance by awarding points. The host can also participate indirectly in this competition, because for each participant who has agreed to participate but has not provided video evidence within the prescribed time, the host is credited with points.

In other embodiment, the game process follows the process explained below:
(i) The HOST defines a Challenge and posts it online so that interested USERs can declare their participation until the expiration of a deadline specified in the Challenge;
(ii) All USERS who have accepted the invitation to participate then have a time window specified in the challenge to solve the challenge and upload the solution to the platform to document this. These are usually short videos that show the PARTICIPANT performing, for example, the number of push-ups required in the challenge within a specified time;
(iii) The community has access to all video evidence of a challenge and is invited to rate the performance by awarding upvotes or downvotes. USERS can also comment on the videos or share them with third parties. The number of votes results in a score, which is entered into a challenge table;
(iv) If a USER who has made a binding declaration of participation fails to upload the video proof in time, the HOST will be credited with the number of points specified in the challenge;
(v) Alternatively, USERS may invite third parties to participate in an existing challenge or create challenges themselves. These USERs then become HOSTs themselves in relation to the USERs they have invited; and
(vi) In this way, all PARTICIPANTS can enter a challenge without being in the same place and solving the challenge at the same time. The competition table is valid for a specified time. After that, the task can be set again.

In some embodiment, the contest is based on the decisions of the community. Every participant's content can be judged by every member of the community with an upvote or a downvote. Every participant in the contest is reflected in the leadership board. The leadership board includes information regarding the participant's name, nationality, total account balance of points and the ranking. To win the contest, participants can collect points by participating in challenges. The sum of collected points in relation to other participant determines the participants ranking.

How to Collect Points

Create a Challenge

A Participant produces a film that shows an activity. Furthermore, the Participant sets requirements that are needed to fulfill the activity. These requirements act as information for challenge Participants and viewers to have a broad overview about the requirements to pass the challenge. The Participant uploads the video and suggests it to be published. Challenge administration checks the suggestion and publishes it on the platform.

Participate in a Challenge

A Participant can join challenges and collect points to increase their account and climb up the ranking. If a user decides to join a challenge, the user must complete different levels to accomplish the task and collect the point of the community. As the goal is to create a commitment to be active in the challenge and credibility, it makes sense to set different time targets for the user and incentivize the upload of the participation. To create the commitment and avoid outstanding uploads, a user faces a deadline to upload the proof video. The deadline should be linked to the difficulty of a challenge. If the Participant can upload the video within the deadline, it will be published to the community. To incentivize the community to vote for the Participant's video, it would also make sense to only allow votes during a timeslot. One the timeslot is over, the sum of upvotes subtracted by downvotes equal the amount of points the Participant was able to collect for the challenge.

Invite Participant to a Challenge

Users can join challenged independently and will have to accomplish the challenge in a given deadline. User can also generate invitations and send them out to other users in order to challenge them. To incentivize interactions with these invitations, it makes sense to set limited validity. Once a host sends out the invitations, invitees have a limited timeslot to answer whether they decline the invitation or they accept it. If a user accepts the invitation, he/she will face the same timeslots that a Participant in a challenge faces. But the difference now is, if the deadline is missed, the host of the invitation will automatically collect points that are added the hosts account balance.

In FIG. 1, USER has an endpoint device (User device A, User device B, User device N) for an online game. The endpoint device can be a mobile, a hand-held device, computer device and it has a processor 510A, 510B, 510N and a memory so the user can install an application on the device. A user device may execute the user application 520A, 520B, 520N allowing a user of the user device to interact the networking system of online game 700. For example, the user application may be a web browser application. In an embodiment, the user application is special-purpose client application, which may utilize an application programing interface to directly interface with the networking system of the online game. The user devices 500A, 500B, 500N are configured to communicate with the networking system of online game 700 via a network 600 or collection of networks-such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. The network 600 may be wired, wireless, or a combination of both 601. User can share or upload a proof video to the networking system 700 via network 600. The networking system comprises a processor 710, Web server 711, network interface 712, Content creator 720 and Data stores 740. The web server 711 links the networking system 700 via the network 600 to one or more user devices 500A-500N by accepting requests for from the user devices 500A-500N and/or transmitting web pages or other web-related content to the user devices 500A-500N, such as image files, audio files, video files, Java applets, Flash, XML, JavaScript, Cascading Style Sheets (CSS), and so forth. The web server 711 in some embodiments is configured to utilize a set of one or more network interfaces 712 to send and receive a proof video across the network 600. In some embodiments the web server 711 (additionally or alternately) utilizes a dedicated software application to communicate with the user devices 500A-500N, which is operative to send and/or receive a proof video, audio, text (e.g., email), text and SMS (Short Message Service) messages, or utilize any other suitable messaging technique. Content creator 720 for automatically identifying content creators from resources shared between users of the networking system 700. The content creator 720, in the depicted embodiment, includes an identification module 721 for identifying one or more creators and/or one or more candidate creators of content from a shared resource, and a validation module 722 for verifying that the creators are legitimate and/or for verifying which of the candidate creators are most likely to be the legitimate creator of shared content. Data stores 740 include User vote data 741, point calculator 742, content store 744 and User profile data 745. User vote data 741 collects a vote from other users' vote. Point calculator 742 assists User vote data by calculating each user's sum of the point based on the votes. The content store 146 stores content items associated with user profiles, such as images, videos, and/or audio files. Content items from the content store 745 may be displayed when proof evidence is viewed or when other content associated with the proof evidence is viewed. For example, displayed content items may show images or video associated with proof evidence or show text describing a mission accomplished evidence. A user profile data 745 includes declarative information about the user that was explicitly shared by the user, and may also include profile information inferred by the networking system 700. In one embodiment, a user profile data 745 includes multiple data fields, each data field describing one or more attributes of the corresponding user of the networking system 700. A user profile data 745 includes a user account 746, which is each user's personal account in the networking system 700. Each user has at least one account and a user account 745 can be allocated to each user to receive a point or an award from a game. The networking system 700 can create the user's account along with the user's profile. The user account 745 can be affiliated with a bank account.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

Where this application has listed the steps of a method or procedure in a specific order, it may be possible, or even expedient in certain circumstances, to change the order in which some steps are performed, and it is intended that the particular steps of the method or procedure claim set forth herein below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

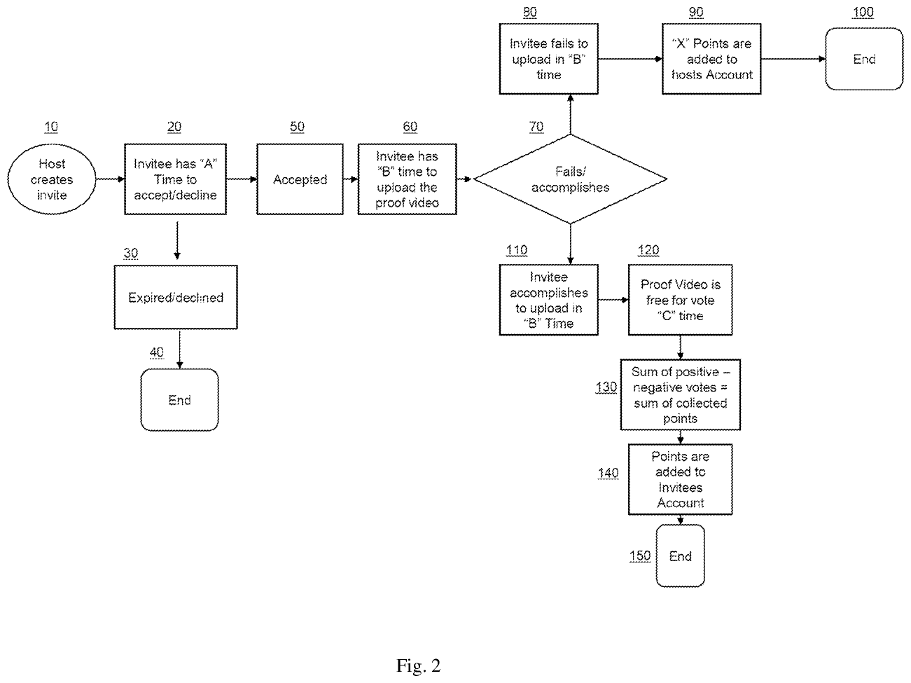

In FIG. 2, A HOST creates a challenge to invite USERS as a game at the step 10. USERs can be a HOST and creates a challenge and points for the game. Invitee has a limited to time, “A,” to accept or decline a challenge at the step 20. “A” can be a pre-determined time or a time window, which is decided by the HOST for the game. If the time is expired in time “A” or declined by invitee at the step 30, the game ends at the step 40. The invitee has accepted the challenge at the step 50. The invitee has a limited time, “B,” to upload a proof video of the accomplishment of the given challenge from HOST at step the 60. “B” can be another pre-determined time or a time window, which is decided by the HOST for the game. The purview of the poof video doesn't limit but can be extended to images, audio, text, or any type of materials. The content of the proof video can be shared in a network service. The USERs may share the content by sending or posting electronic messages to the social networking system that include resource identifiers (e.g., “links” or hyperlinks, such as a Uniform Resource Locator (URL) or Uniform Resource Identifier (URI)) that identify “online” content, which is typically provided by a third party server reachable through the Internet. When a user shares a content including a URL (i.e., resource identifier), the user device of the user transmits a sharing content including the message and the URL to the social networking system (or a network service otherwise receives a URL), which retrieves the resource (e.g., a web page and possibly additional information referenced by the web page, such as images, videos, formatting code (e.g., a style sheet), etc.) identified by the URL. The resource—or set of one or more files—includes content that the user is attempting to share. For example, a user may share a URL of a webpage that includes a video (i.e., the content), though the webpage may also include other text, multimedia, advertisements, etc. Many forms of content exist, and may include an article, an essay, a photograph, an illustration, a movie/video, a game, a tutorial, source code for a computer program, a combination of one or more of these items, or any other type of information or data available on the internet. At the step 70, a HOST or a computer system decides if the invitee is failed or succeeds in uploading the proof video. If the invitee fails to upload the proof video in the limited time, “B,” at the step 80, the HOST has “X” points in his/her account at the step 90. The “X” could be created by the HOST for the game participants when the HOST provides the challenge in a game. The points can be cash, cyber coins, or any type of awarded points. The account can be created by the HOST or user in the game. The game account is allocated to the HOST and each user. The game ends at the step 100. However, if the invitee succeeds in uploading the proof video in the limited time, “B,” at the step 110, the uploaded proof video is free for vote by the USERs in the game and optionally third parties in the public in a limited time, “C,” at the step 120. “C” can be another pre-determined time or a time window which is decided by the HOST for the game. The invitee can have a sum of collected points on his/her account at the step 140. The sum of collected points can be calculated by subtracting a sum of negative votes from a sum of positive votes at the step 150. The game ends at the step 150.

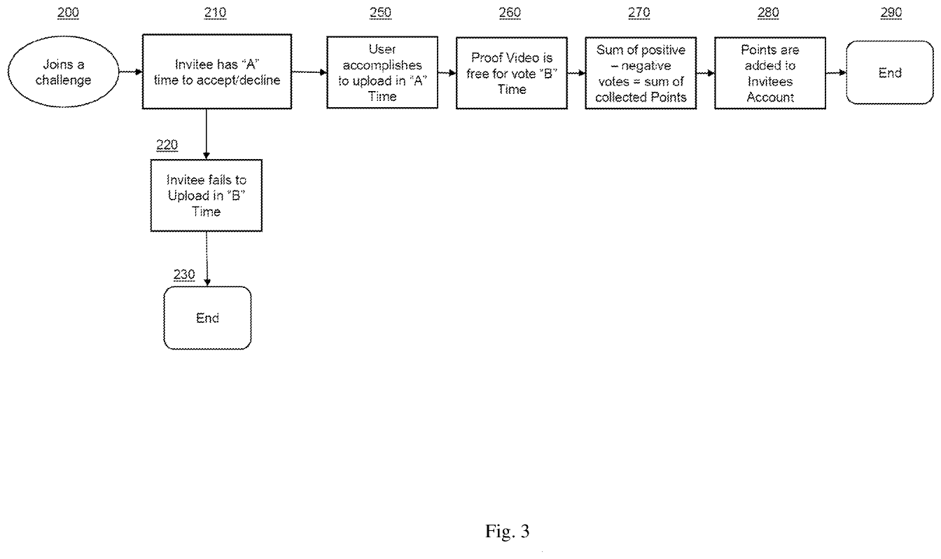

In FIG. 3, users can join challenged independently in a game at the step 200. The user can also generate an invitation of the challenges and send them out to other users in order to challenge them. An invitee has a limited time, “A,” to accept or decline the challenge at the step 210. “A” can be a pre-determined time or a time window, which is decided by the HOST for the game. If the invitee fails to upload a proof video in “B” time at the step 220, the game ends at the step 230. “B” can be another pre-determined time or a time window, which is decided by the HOST for the game. If a user or an invitee accepts the challenge and succeeds in uploading a proof video in “A” time or accomplishes the challenge at the step 250, the proof video is free for vote by the USERs in the game and optionally third parties in the public in a limited time, “B,” at the step 260. The invitee can have a sum of collected points at the step 270. The sum of collected points can be calculated by subtracting a sum of negative votes from a sum of positive votes with respect to the proof video from the USERs or the third parties at the step 280. The game ends at the step 290.

The following should be noted:
(1) The drawings of the embodiments of the present disclosure only refer to the structures related to the embodiments of the present disclosure, and other structures may refer to the general design.
(2) For the sake of clarity, in the drawings used to describe embodiments of the present disclosure, the thicknesses of layers or regions are enlarged or reduced, that is, these drawings are not drawn to actual scale. It should be understood that in a case where an element such as a layer, a film, a region or a substrate is referred to as being “on” or “under” another element, the element may be directly “on” or “under” the other element or intervening elements may be present.
(3) Without conflict, the embodiments of the present disclosure and the features in the embodiments can be combined with each other to obtain new embodiments.

What are described above are illustrative embodiments of the present disclosure only and not limitative to the scope of the present disclosure. Any changes or substitutions that are easily for those skilled in the art to envisage should within the technical scope disclosed in the present disclosure. Therefore, the protection scope of the present disclosure should be based on the protection scope of the accompanying claims.

What is claimed is:

1. A method in an online social platform for online game between a networking system and users' device and a content to be shared in a network service comprising:
creating in a content creator a challenge to invite users in a game, wherein the content creator has an identification module and a validation module;
sending an invitation to the users' device to accept the created challenge in a predetermined time via a network;
expiring, by a processor, in the networking system, a predetermined time when a networking system does not receive a response from a user's device to accept the challenge in the predetermined time;
sending the content from a user application to a data stores in the networking system via a network in a predetermined time after the response is received from a user's device,
wherein the content is a proof video accomplishing the challenge;
deciding, by the processor, whether the content is uploaded on a data stores in the predetermined time;
voting, by the processor, in the users' device, a positive or a negative point in a predetermined time when the uploaded content is shared between the users' device; and
collecting, by the processor, a sum of the points from the voting and saving the collected points on a user's account.

2. The method of claim 1, wherein a further step of the expiring a time automatically ends a game within the time, wherein the processor sets the time.

3. The method of claim 1, wherein the points are saved in a host's account instead of the user's account when the content is not uploaded on the data stores in the predetermined time.

4. The method of claim 1, wherein the collected points from the voting is summed in a point calculator by subtracting a sum of negative votes from a sum of positive votes from user devices.

5. The method of claim 1, wherein the user application is provided from the web server in a networking system and installed in the user device to send a content from the user application.

6. the method of claim 1, wherein the identification module is identifying one or more creators or one or more candidate creators of the content.

7. the method of claim 6, wherein the verifying module is verifying which of the candidate creators are the legitimate creator.

8. the method of claim 1, wherein the accomplished content is shared between the users' device through a networking system.

9. the method of claim 5, wherein a user's profile and host's profile are created in the networking system when the application is installed on user's devices and include multiple data fields.

10. the method of claim 9, where the user's profile and host's profile include an account information to receive the collected points.

11. A system in an online social platform for online game between a networking system and users' device and a content to be shared in a network service comprising:
a processor configured to:
create in a content creator a challenge to invite users in a game, wherein the content creator has an identification module and a validation module;
send an invitation to user devices to accept the created challenge in a predetermined time via a network;
expire in the networking system, a predetermined time when a networking system does not receive a response from a user's device to accept the challenge in the predetermined time;
send the content from the user application to a data stores in the networking system via a network in a predetermined time after the response is received from a user device,
wherein the content is a proof video accomplishing the challenge;
decide whether the content is uploaded on a data stores in the predetermined time;
vote in the users' device a positive or a negative point in a predetermined time when the uploaded content is shared between the users' device; and
collect a sum of the points from the voting and save the collected points on a user's account.

12. The system of claim 11, wherein a further step of the expiring a time automatically ends a game within the time, wherein the processor sets the time.

13. The system of claim 11, wherein the points are saved in a host's account instead of the user's account when the content is not uploaded on the data stores in the predetermined time.

14. The system of claim 11, wherein the collected points from the voting is summed in a point calculator by subtracting a sum of negative votes from a sum of positive votes from user devices.

15. The system of claim 11, wherein the user application is provided from the web server in a networking system and installed in the user device to send a content from the user application.

16. The system of claim 11, wherein the identification module is identifying one or more creators or one or more candidate creators of the content.

17. The system of claim 16, wherein the verifying module is verifying which of the candidate creators are the legitimate creator.

18. The system of claim 11, wherein the accomplished content is shared between the users' device through a networking system.

19. The system of claim 15, wherein a user's profile and the host's profile are created in the networking system when the application is installed and includes multiple data fields.

20. The system of claim 19, where the user's profile and the host's profiles include an account information to receive the collected points.
